(19) United States
(12) Patent Application Publication
(10) Pub. No.: US 2007/0193408 A1
(43) Pub. Date: Aug. 23, 2007

(54) Gear Box Arrangement

(76) Inventor: Monica Gil Martinez, Madrid (ES)

Correspondence Address: DEERE & COMPANY, ONE JOHN DEERE PLACE, MOLINE, IL, 61265, US

(21) Appl. No.: 11/670,156

(22) Filed: Feb. 1, 2007

(30) Foreign Application Priority Data
Feb. 7, 2006 (DE) 10 2006 005 354.0

(51) Int. Cl. F16P 1/00; G05G 25/00

(52) U.S. Cl. 74/609

(57) ABSTRACT

A gearbox arrangement includes a gearbox housing, a first shaft supported in bearings in the housing, the first shaft containing a cavity which extends eccentrically to the axis of rotation of the first shaft, a second shaft supported in the cavity for rotation and having an end region projecting from the cavity and being provided with gear teeth, and a third shaft supported in the gear box housing for rotation, with the axis of rotation of the third shaft cooperating with the axis of rotation of the first shaft to define a plane. Leakage of lubricant from the housing is prevented by fastening a plate to the first shaft so as to prevent axial movement of the second shaft while containing an opening for the end region of the second shaft. Sealing devices are provided for all of the openings of the gearbox housing as well as for the opening in the plate in order to prevent the escape of lubricant from the gearbox housing.

### FIELD OF THE INVENTION

The invention concerns a gearbox arrangement with a gear box housing, a gearbox chamber enclosed by the gearbox housing, a first shaft supported in bearings in the gearbox housing, a cavity configured eccentrically to the axis of rotation with the center of gravity of its cross section, a second shaft supported in bearings, free to rotate, in the cavity of the first shaft which is provided with at least one area of gear teeth and a shaft end section projecting axially out of the cavity of the first shaft a, and a third shaft supported in bearings in the gearbox housing whose axis of rotation extends at an angle to the plane lying on the axis of rotation of the first shaft.

### BACKGROUND OF THE INVENTION

Gearbox arrangements are known in the state of the art that are provided with gear rations arranged at angles to each other with gearbox shafts arranged within each other. Gearbox arrangements with gearbox shafts arranged within each other represent, among other factors, compact configuration and the possibility of attaining eccentric drives. Gearbox arrangements with eccentric drives are applied, for example, in agriculture for drives of cutterheads on front mowing attachments for combines.

Such a gearbox arrangement is disclosed, for example in U.S. Pat. No. 6,273,214 B1. The gearbox arrangement is provided with a gearbox housing in which a gearbox shaft is supported in bearings that can be driven by an angle drive stage and is provided with a cavity that is located eccentrically. An eccentric shaft is supported in bearings in the cavity and is connected with a journal. The gearbox arrangement disclosed is operated with lubricating grease. In order to assure a sufficiently large supply of lubricating grease to the cavity, a channel is provided that connects a region of the gearbox arrangement with the cavity of the shaft. The lubricating grease deposited in the gearbox chamber can reach the cavity through the channel. The difficulty here lies in the sealing of the cavity relative to the gearbox housing or the sealing of the eccentric shaft relative to the gear box shaft, which requires a costly configuration for the axial securing of the eccentric shaft and a large assembly cost connected with it. Moreover, a further disadvantage results from the fact that the lubricating grease can escape through the openings of the gearbox housing or the gearbox shaft after only a few hours of operation and that topping off of the lubricating grease results in very short maintenance intervals. Furthermore, it is difficult to verify whether there still is a sufficient supply of lubricating grease in the interior of the gearbox arrangement.

The purpose of the invention is seen in the need to define a gearbox arrangement of the type noted initially, through which one or more of the aforementioned problems are overcome.

### SUMMARY OF THE INVENTION

According to the present invention, there is provided an improved gearbox arrangement, especially an arrangement for reliably containing lubricating grease.

According to the invention, a gearbox arrangement of the kind noted initially is configured in such a way that the gearbox arrangement is provided with a plate fastened to the first shaft, fixed against rotation, for immobilizing the second shaft in the axial direction, where an opening is provided in the plate for the shaft end region and that openings of the gearbox housing as well as the opening in the plate are provided with sealing devices that seal the lubricant located in the gearbox housing in order to prevent its escape between the gearbox housing and the first and the third shaft or between the plate and the second shaft. Since a plate is provided to immobilize the second shaft in the axial direction, on the one hand the cost of the assembly can be reduced considerably and poorly accessible snap rings can be avoided, and on the other hand, a sealing device can be placed in the opening, that seals the second shaft to the outside so that no lubricant can escape through a clearance gap between the second and the first shaft. The other sealing devices at the openings of the housing at the exits of the first and second shaft correspondingly seal the gearbox housing as effectively. All told, the sealing devices prevent leakage of lubricant which require short maintenance intervals at gear box arrangements known in the state of the art. With a gearbox arrangement according to the invention, the loss of lubricant through leakage and the cost of assembly can be reduced considerably and the maintenance intervals can be lengthened significantly.

In a preferred embodiment of the invention, the plate is bolted to the end face of a shaft end region of the first shaft. The plate can be assembled and disassembled easily by the use of threaded bores distributed over the circumference at the edge of the end face of the first shaft, preferably three bores are used. Moreover, a further sealing device can be provided between the end face of the first shaft and the plate so that here, too, an escape of lubricant can be prevented. In addition to accommodating the sealing device for the second shaft, the plate is also used to protect the clearance gap against intruding dirt.

Preferably, the gearbox housing is provided with one or more closure plugs arranged along the axis of rotation of the first shaft. The closure plugs are used to fill the gearbox arrangement with lubricant, to check the quantity of lubricant remaining or to create a drain opening for the lubricant. In that way, a closure plug arranged at a relatively high level can be used to fill the housing with lubricant, on the other hand a closure plug arranged at a relatively lower level can be opened to permit a drainage of lubricant or to check whether lubricant drains out of that opening. If no lubricant drains from that closure plug, then there is insufficient lubricant in the housing and must be topped off. Thereby, a costly disassembly of components during the maintenance can be avoided.

Alternatively, a measuring rod can also be arranged on the housing wall that extends into the interior of the housing.

The sealing devices are preferably configured as shaft sealing rings, for example, as radial packing rings that are inserted into the gearbox housing or in the cavity of the first shaft and are forced by ring-shaped garter springs against sealing sleeves of oil-resistant artificial rubber and are used to seal openings for shafts against leakage of lubricant or entry of dust. However, other sealing devices can be applied that seal a rotating shaft relative to an opening.

A gearbox arrangement according to the invention has the advantage that gear oil can be used as a lubricant so that the entire gearbox arrangement can be operated with gear oil. In contrast to lubricating grease, gear oil has more advantageous temperature characteristics. Moreover, the maintenance process is simplified by the use of gear oil for the lubrication of the gear arrangement, since with the use of the closure plugs the filling up, measurement of the oil level and draining of the gear oil can be performed without any cost. Due to the arrangement according to the invention of corresponding shaft sealing rings, or other sealing devices, any leakage of gear oil is prevented. It should be noted here that other types of lubricants, particularly lubricating grease, can also be applied for the operation of the gearbox arrangement.

The plate provided for the immobilizing of the second shaft and for the location of a sealing device for the sealing of the second shaft is preferably arranged in such a way that a bearing arranged in the first bearing region of the second shaft is immobilized axially at the first shaft by the plate. Thereby, snap rings for the immobilizing of the bearing of the second shaft in the axial direction that are poorly accessible or other costly attachment measures for the bearing of the second shaft can be omitted. By pressing the plate, the bearing located in the bearing region of the second shaft is forced against a step of the first shaft and retained there or immobilized.

The second shaft is supported in bearings, free to rotate, in the cavity of the first shaft, where the second shaft is preferably configured as a one-piece component. Since the second shaft is configured as a one-piece component and, in particular, the shaft end region is configured as a part of the shaft, connecting components are omitted, the susceptibility to failure is reduced and the manufacturing process and the assembly are simplified. Preferably the second bearing region is arranged between the gear tooth area and the shaft end region. The second shaft may be supported bin bearings by two bearing seats spaced axially in the cavity of the first shaft. Preferably, the first bearing region of the second shaft is equipped with a rolling contact bearing, particularly a needle bearing, where the first bearing seat is preferably arranged in the area of the cavity opening of the channel in the interior of the gearbox interior of the first shaft. In view of the relatively small dimensions of a needle bearing, a compact configuration can be attained. The second bearing seat for a second rolling contact bearing is preferably arranged at a cavity opening located at the outside of the first shaft. The second rolling contact bearing is configured, for example, as a ball bearing and is located in the second bearing region of the second shaft. Obviously other combinations are conceivable with other types of rolling contact bearings. Moreover, it is conceivable that the bearing areas are also arranged directly alongside each other so that the shaft end region as well as the gear tooth area are freely arranged in bearings. Preferably the second shaft is configured in such a way that the maximum outside diameters in the various regions increase towards the shaft end region. Thereby, a shaft end region with a relatively large outside diameter is attained whereby a shaft step towards the shaft end region is used as an axial security device for the second rolling contact bearing. Moreover, a simple pre-assembly of the second rolling contact bearing on the shaft is thereby attained, so that the second shaft can be assembled in one working cycle and particularly the assembly time or the maintenance time for the gearbox arrangement are shortened.

The gear tooth region configured between the at least one bearing region and the shaft end region meshes with a set of gear teeth connected to the gearbox housing, fixed against rotation, preferably an internal gear. For this purpose, the cavity of the first shaft is provided with a radial opening that extends over a part of the circumference of the first shaft and partially frees the gear tooth region.

A rotation of the second shaft can be attained in itself in the cavity of the first shaft by the meshing of the gear tooth region with the set of gear teeth connected, fixed against rotation, with the gearbox housing, so that a superposition of an eccentric movement of the second shaft about the axis of rotation of the first shaft can be attained with a rotational movement of the second shaft about its own axis of rotation.

The gearbox arrangement is provided with a third shaft, supported in bearings in the gearbox housing, whose axis of rotation extends at an angle to the plane lying on the axis of rotation of the first shaft. Preferably, the third shaft is arranged in such a way that the axes of rotation of the first shaft and that of the third shaft intersect in a point and thereby lie in a common plane and extend at an angle of approximately 90°. It is also possible, however, to arrange the third shaft in an offset position, so that the axes of rotation of the first and the third shafts do not lie in a common plane. Moreover, it is also possible to arrange the shafts so that they extend at a larger or a smaller angle to each other.

The third shaft is preferably supported in bearings axially loose in a first bearing, where the first bearing of the third shaft is configured as a roller bearing, in particular a needle bearing. Here is it also possible to apply other types of rolling contact bearings, for example, a ball bearing that is immobilized axially in both directions on a shaft or in a bearing seat and the shaft is supported in bearings so that it is axially loose. The use of a needle bearing as a loose bearing has the advantage that the shaft can be configured very compactly and simply.

The third shaft is preferably immobilized axially in both directions in the gearbox housing in a second bearing. Preferably the second bearing of the third shaft is configured as a rolling contact bearing, particularly a ball bearing, that is immobilized axially by a step on the gearbox housing towards the interior of the gearbox housing and by a snap ring at the gearbox housing to the outside of the gearbox housing. By immobilizing it in both directions of the gearbox hosing by means of a snap ring, it is possible to pre-assemble the third shaft and to insert it into the gearbox housing in a single working cycle. Thereby, assembly time and maintenance time can be reduced.

The gearbox arrangement is provided with a gear arranged on the third shaft that can be immobilized in one direction axially by a snap ring. With the use of a snap ring for the fastening of a gear, a step on the shaft that is costly to manufacture can be avoided whereby the entire shaft can be configured more simply and as a result the manufacturing cost can be reduced.

A gear fastened to the first shaft meshes with the gear fastened to the third shaft, where the gear of the first shaft is immobilized in the first bearing of the first shaft radically to the axis of rotation of the first shaft and applies an axial force with respect to the third shaft.

The third shaft is immobilized in both directions by the axial force and the snap ring arranged at the gearbox housing for the second bearing of the third shaft.

The interior of the gearbox hosing is connected with the surroundings of the gearbox housing by a ventilation arrangement provided on the gearbox housing, for example, on a gearbox hosing cover, the ventilation arrangement may be a ventilation opening, a small ventilation tube, a ventilation valve, an over-pressure valve or the like. Through the connection with the surroundings, a pressure equalization can take place between the interior of the gearbox arrangement and the surroundings, so that operating temperatures can be reduced and the durability can be increased.

The gearbox arrangement is preferably provided with a journal that extends axially out of the shaft end section axially and eccentrically to the axis of rotation of the second shaft. Here the journal may be a part of the on-piece second shaft or it may be connected to the second shaft by connecting devices. The rotation of the first and the second shafts results in a superposition of an eccentric rotational movement of the axis of rotation of the second shaft about the axis of rotation of the first shaft and an additional eccentric rotational movement of the journal about the axis of rotation of the second shaft. Thereby, the journal is used to transmit the superimposed eccentric movements into corresponding linear movements on an arrangement that can be drive, for example, a cutter head.

In order to transmit the rotational movements, the journal is preferably equipped with a rolling contact bearing that can be connected with a bearing pan which is connected with an arrangement that can be driven. Depending on the rotational speed of the journal or the shafts and the forces to be transmitted, a sliding bearing could be used instead of the rolling contact bearing, the sliding contact bearing may, for example, be provided in the form of a sliding bushing. The rolling contact bearing of the journal may be configured as a roller bearing. The rolling contact bearing is enclosed in a bushing that is preferably configured in the shape of a ring and is provided with a spherically bowed outer surface. The rolling contact bearing is taken up in the bushing by means of a race of the rolling contact bearing that is pressed into the inner surface of the bushing. The spherically bowed outer surface in turn, is taken up by a bearing pan that is configured with an inner surface congruent to the outer surface of the bushing. The spherical surfaces permit a relative movement of the parts to each other so that an angle of inclination of the parts to each other can be adjusted between the journal and the arrangement to be driven or between the longitudinal axis of the journal and the rotational axis of symmetry of the bearing pan, whereby tolerance problems during the transmission of movements can be overcome. Moreover, it is possible to configure the bearing as a ball bearing whose outer race is engaged in a corresponding bushing. Here a needle bearing is used that includes an outer race with a spherically bowed outer surface. Another type of rolling contact bearing could also be used, for example, a ball bearing or a roller bearing could be provided with an outer race with such a shape.

The bushing that engages the outer race as well as the bearing pan that encloses the bushing are configured as closed around their circumference. Recesses or openings are provided on the bearing pan located opposite each other in the radial direction and that extend axially to the axis of rotational symmetry of the bearing pan along the inner surface of the bearing pan. The openings are dimensioned in such a way that when the bushing engages the bearing pan the bushing can be inserted in its width transverse to its axis of rotational symmetry and by pivoting through 90° the outer surface of the bushing is oriented to the inner surface of the bearing pan and brought into bearing position. Previous configurations are provided with a bushing that is open around its circumference or is slotted, mostly of plastic, that is engaged by a bearing pan with an open configuration. The slotted bushing is stretched around the rolling contact bearing of the journal by a stretching arrangement at the bearing pan. Since the bushing and the bearing pan are configured as closed around their circumference, on the one hand the connection between the rolling contact bearing and the bushing or the bearing pan can be made without any costly stretching arrangements, on the other hand stronger materials and materials more resistant to wear can be used and thereby the maintenance intervals can be lengthened and the susceptibility to failure can be reduced. Moreover, the result is also a lower bearing clearance. A gearbox arrangement with a rolling contact bearing for the journal and the use of a bushing and a bearing pan that are configured as closed in the above described configuration and are provided with spherical surfaces, can be seen as an independent invention

The bearing pan for the rolling contact bearing of the journal is preferably connected to connecting devices, particularly connecting devices for the connection with a cutter head. For example, the bearing pan is connected directly with a guide rod or a drive rod, through which a cutter movement is brought about. The connection with the bearing pan can be made, for example, by welding or bolting. Moreover, it is possible to configure the bearing pan and the connecting device as a one-piece component, for example, to forge or to cast it.

### BRIEF DESCRIPTION OF THE DRAWINGS

The drawing shows and embodiment of the invention on the basis of which the invention as well as its advantages and the advantageous further developments and embodiments of the invention shall be explained and described in greater detail in the following.

FIG. 1 is a cross sectional view of a gearbox arrangement constructed in accordance with the principles of the present invention.

FIG. 2 is a side view of the gearbox arrangement of FIG. 1.

FIG. 3 is a perspective view of the gearbox arrangement of FIG. 1.

FIG. 4 is a detailed view of the second shaft of the gearbox arrangement of FIG. 1.

FIG. 5 is a plan view of the shaft end section of the second shaft shown if FIG. 4.

FIG. 6 is a side view of a journal arrangement of the gearbox arrangement of FIG. 1.

FIG. 7 is a plan view of the journal arrangement of FIG. 6.

FIG. 8 is a plan view of the plate of the gearbox arrangement of FIG. 1 with an opening for the second shaft.

FIG. 9 is a cross sectional view of the plate shown in FIG. 8.

FIG. 10 is a cross sectional view of a bearing for a journal of the gearbox arrangement shown in FIG. 1

### DESCRIPTION OF THE PREFERRED EMBODIMENT

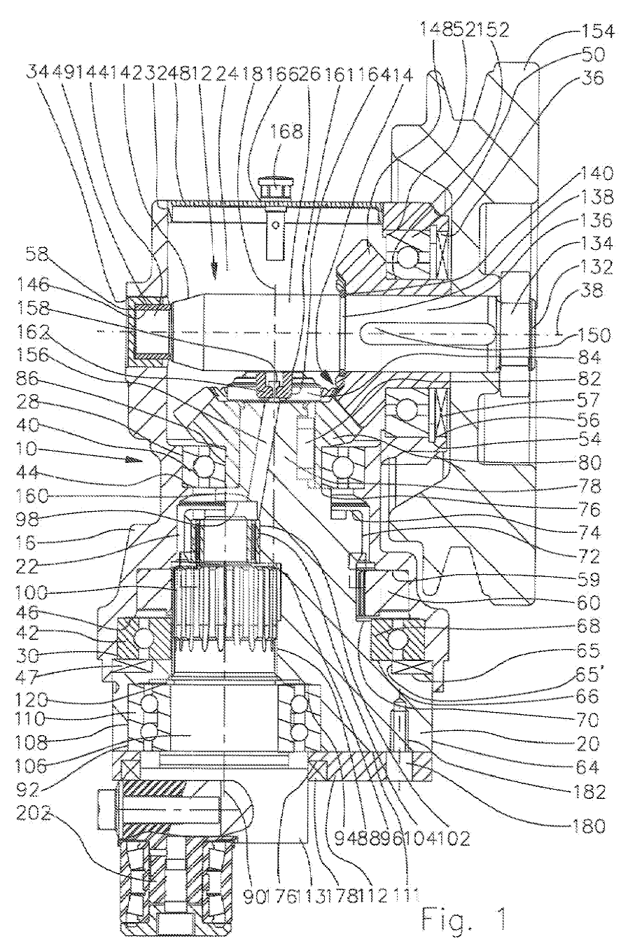

FIGS. 1 through 3 show a gearbox arrangement 10 constructed in accordance with the present invention, with a gearbox chamber 12 of an angle gearbox 14 being surrounded by a housing 16. The gearbox housing 16 extends generally rotationally symmetrical along an axis of rotation 18 of a first shaft 20, where the axis of rotation 18 defines the longitudinal direction of the gearbox arrangement 10. the gearbox chamber 12 is subdivided into a first gearbox chamber region 22, that generally surrounds the first shaft 20, and a second gearbox chamber region 24, that generally surrounds a third shaft 26 arranged transverse to the longitudinal direction. The gearbox chamber regions 22, 24 are configured as adjoining each other in the longitudinal direction and are provided with a common cylindrical transition region 28, that is arranged approximately in the center of the longitudinal extent of the gearbox housing 16 and coaxially to the axis of rotation 18, and through which an axial connection of the gearbox chamber regions 22, 24 is defined.

The gearbox housing 16 is provided with a first cylindrical opening 30 in the first gearbox chamber region 22, that is oriented coaxially to the axis of rotation 18 and that opens the first gearbox chamber region 22 axially to the outside. Moreover, the gearbox housing 16 is provided with first, second and third cylindrical openings 32, 34 and 36, respectively, in the second gearbox chamber region 24. The second opening 32 is oriented coaxially to the axis of rotation 18 and opens the second gearbox chamber region 24 axially to the outside. the third and fourth openings 34, and 36, respectively are arranged to either side of the axis of rotation 18 and coaxially to an axis of rotation at the third shaft 26 arranged transverse to the axis of rotation 18.

A first bearing 40 is arranged in the common transition region 28, and a second bearing 42 is arranged in the first opening 30 in the first gear box chamber region 22 for the first shaft 20. A step 44 is formed onto the common transition region 24 which axially immobilizes the bearing 40 in the direction of the first opening 30. A step 46 is formed onto the first opening 30 that axially immobilizes the bearing 42 in the direction of the common transition region 28. The bearings 40, 42 are preferably configured as rolling contact bearings and as an example are pictured in FIG. 1 as ball bearings. The first shaft 20 is supported in the bearings 40 and 42, free to rotate, in the gearbox housing 16 or the first gearbox chamber region 22. Moreover, a first shaft seal ring 47, for example, a radial packing ring, is provided at the first opening 30 adjacent to the second bearing 42 that seals the clearance gap between the first opening 30 and the first shaft 20 to the outside.

A housing cover 48 is provided in the second gearbox chamber region 24 at the second opening 32 that encloses the second gearbox chamber 12 axially to the surroundings.

A first bearing 49 is arranged in the second gearbox chamber region 24 at the third opening 34, and a second bearing 50 in the fourth opening 36 for the third shaft 26. A step 52 is formed onto the fourth opening 36 that axially immobilizes the bearing 50 in the direction of the third opening 34. Moreover, a ring groove 56 is formed onto the fourth opening 36 and is provided with a snap ring 54, whereby the bearing 50 is also immobilized in the opposite direction. The bearing 49 is freely supported and arranged in the third opening 34. The bearings 49, 50 are preferably configured as rolling contact bearings, where in the case of the bearing 49 a roller bearing in the form of a needle bearing is used, as can be seen in FIG. 1. In the form pictured, the bearing 50 is configured as a ball bearing, where here a roller bearing could also be applied. The third shaft 26 engages the bearing 49 and 50 and is supported in these bearings, free to rotate, in the gearbox housing 16 or in the second gearbox chamber region 24. Moreover, a second shaft sealing ring 57, for example, a radial packing ring sealing to the outside, is arranged at the fourth opening 36 adjacent to the snap ring 54, that seals the clearance gap between the fourth opening 36 and the third shaft 26. A bearing bushing 58, provided at the third opening 34, seals the third opening 34 to the outside.

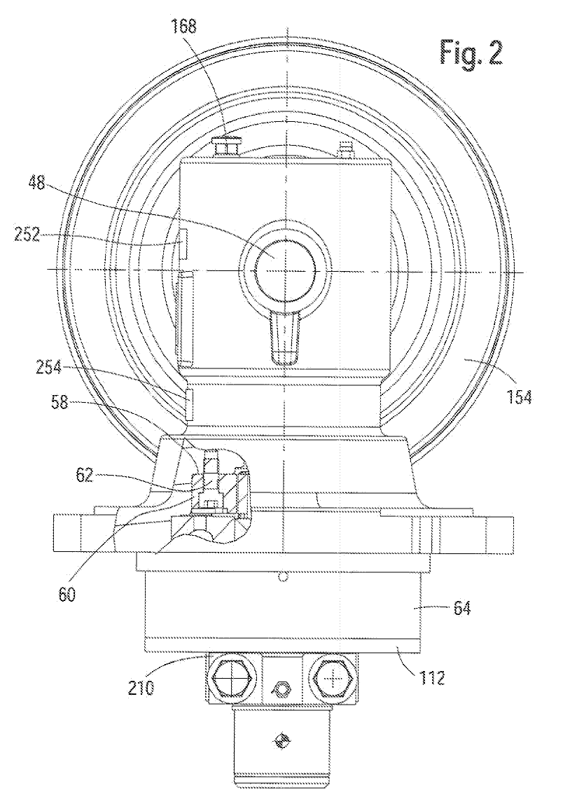

Moreover, a further step 59 is provided in the first gearbox chamber region 22 between the bearings 40, 42, to which an internal gear 60 is fastened. The internal gear 60 is bolted to the gearbox housing 16 by means of screws 62 distributed around the circumference of the step 59 (see FIG. 2).

The first shaft 20 extends through the entire first gearbox chamber region 22 and is provided with a shaft end region 64 that projects out of the first opening 30 and essentially covers the entire diameter of the first opening 30. Starting from the shaft end region 64, a first shaft step 65 adjoins a shaft seal ring region 65′ for the first shaft seal ring 47. Starting from the shaft end region 64 a second shaft step 66 is formed that adjoins a bearing region 68 for the second bearing 42. A third shaft step 70 is formed adjoining the bearing region 68 that in turn adjoins a central shaft region 72. The central shaft region 72 ends in a fourth shaft step 74. The fourth shaft step 74 is followed by a fifth shaft step 76 that, in turn, adjoins a shaft journal 78, where the shaft journal 78 extends through the common transition region 28 in the second gearbox chamber region 24. A first bevel gear 80 is supported in bearings on the shaft journal 78, it is connected, fixed against rotation, by means of a spring/groove connection 82 to the first shaft 20 or the shaft journal 78. The shaft journal 78 is equipped with a shaft nut 84. A bearing region 86 is configured on the first bevel gear 80 through which the first shaft 20 is engaged in the first bearing 40.

The first shaft 20 is provided with a cavity 88. The cavity 88 is configured generally cylindrical about an axis of rotation 90 where the axis of rotation 90 is arranged parallel to the axis of rotation 18 and eccentrically to the first shaft 20. The cavity 88 is provided with a cylindrical opening 92 that opens the cavity 88 to the shaft end 64 of the first shaft 20 axially to the axis of rotation 90. Starting from the opening 92, the cavity 88 is provided with first and second steps 94, 96 and ends in a cavity floor 98. Between the first and the second steps 94, 96, the cavity 88 is provided with an opening 100 at the level of the internal gear 60, opening 100 extends radially and axially to the axis of rotation 90 along the wall of the cavity and opens a partial region of the wall of the cavity towards the internal gear 60.

A first bearing seat 102 is a configured to accept a first bearing 104 for a second shaft 206 between the second step 96 and the cavity 88 and the cavity floor 98. A second bearing seat 108 is configured to accept a second bearing 110 for the second shaft 106 between the opening 92 of the cavity 88 and the step 94. The second bearing 110 is secured axially by means of a plate 112 bolted to the end face 11 of the shaft end region 64, in that the outer race of the second bearing 110 is pressed against the first step 94.

The first and second bearings 104, 110 for the second shaft 106 are configured as rolling contact bearings, where for the first bearing 104 a roller bearing is provided in the form of a needle bearing, and for the second bearing 110 a ball bearing is provided, as is shown in FIG. 1.

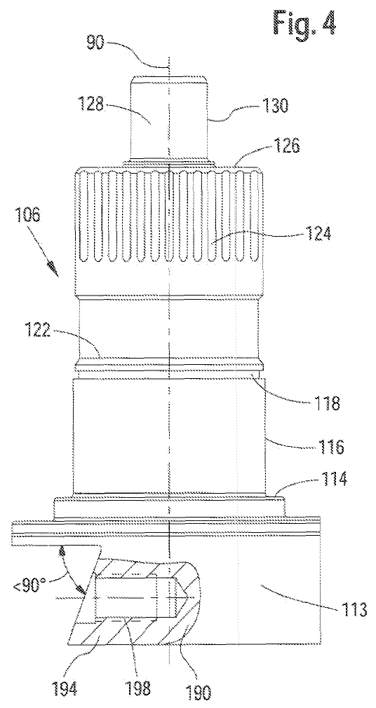

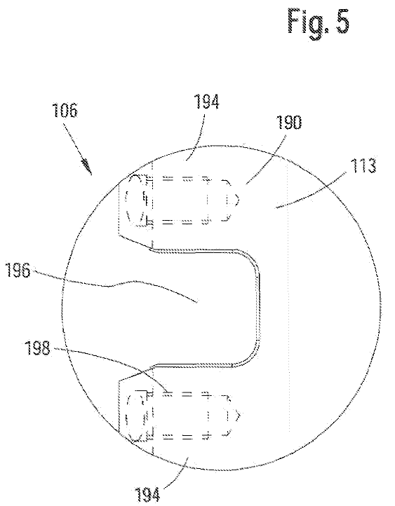

The second shaft 106 extends through the entire cavity 88 of the first shaft 20 and is provided with a shaft end region 113 projecting out of the first opening 92 of the first shaft 20 (see FIG. 4). Starting from the shaft end region 113, the second shaft 106 is provided with a first shaft step 114 that adjoins a bearing region 116 for the second bearing 110. Adjoining the bearing region 116, a ring groove 116 is configured that accepts a snap ring 120 (shown in FIG. 1). The ring groove 118 adjoins a second shaft step 122 that ends in a gear tooth area 124 of the second shaft 106. The gear tooth region 124 of the second shaft 106 extends axially between the shaft steps 94, 96 of the cavity 88 and ends in a third shaft step 126. The third shaft step 126 adjoins a shaft journal 128 on which a bearing region 130 for the first bearing 104 is provided.

The third shaft 26 extends through the entire second gearbox chamber region 24 and is provided with a shaft end region 132 projecting out of the fourth opening 36 (see FIG. 1). The shaft end region 132 is provided with a shaft nut 134. Starting from the shaft end region 132, the third shaft 26 is provided with a shaft region 136 that adjoins a ring groove 138 where a part of the shaft region 136 projects out of the fourth opening 36. The ring groove 138 accommodates a snap ring 140. A shaft step 142 is provided between the ring groove 138 and the third opening 34, it adjoins a shaft journal 144. A bearing region 146 is provided on the shaft journal 144 that engages the first bearing 49 of the second gearbox chamber region 24. a second bevel gear 148 is supported in bearings on the shaft region 136, it is connected with the third shaft 26, fixed against rotation, by means of a spring/groove connection 150. A bearing region 152 is configured on the second bevel gear 148 by means of which the third shaft is engaged in the second bearing 50. Moreover, a belt pulley 154 is provided on the part of the shaft region 136 projecting out of the fourth opening 36, the belt pulley is also connected to the third shaft 26, fixed against rotation, by means of the spring/groove connection 150.

The shaft journal 78 of the first shaft 20 is equipped with a channel 156 that is provided, starting from the end of the shaft journal 78, with a gearbox chamber opening 158 and a cavity opening 160.

The gearbox chamber opening 158 is arranged concentrically to the axis of rotation 18 of the first shaft 20. The cavity opening 160 of the channel 156 is arranged eccentrically to the axis of rotation 18 of the first shaft 20 in the area of the cavity floor 98. The gearbox chamber opening 158 is provided with a thread 161 and a component 162, in particular a closure plug that is configured as an internal hex head or Allen head screw. The component 162 is provided with a bore 164. The component 162 and the bore 164 are arranged concentrically to the axis of rotation 18.

The housing cover 48 is provided with a bore 166 into which a ventilation arrangement 168 is inserted. The ventilating arrangement 168 is configured in the form of a pipe arrangement and extends into the interior of the second gearbox chamber region 24 (see FIG. 1). A filter 172 is arranged in the head 170 of the ventilating arrangement.

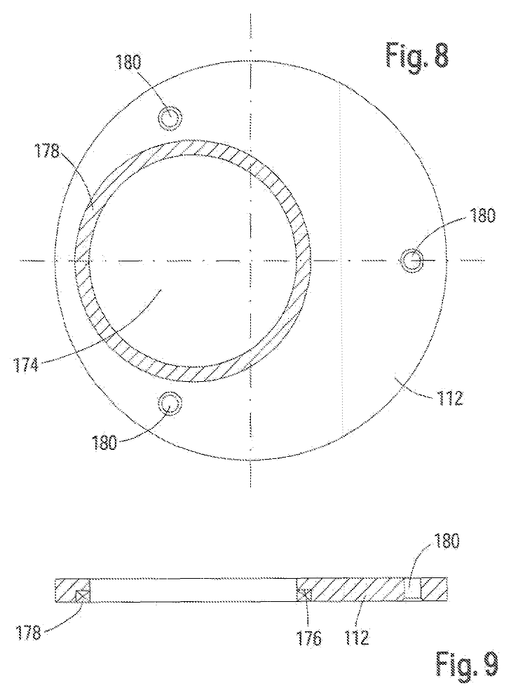

The plate 112 arranged for the immobilizing of the second shaft 106 is pictured in FIGS. 8 and 9. Corresponding to the diameter of the shaft end region 64, the plate 112 is configured cylindricalloy and concentric to the axis of rotation 18 and is provided with an opening 174 for the projection of the shaft end region 113 of the second shaft 106. Corresponding to the eccentric movement of the second shaft 106, the opening 174 is arranged eccentrically to the axis of rotation 18. The opening 174 is provided with a step 176 in which a third shaft seal ring 178 is arranged, sealing to the outside, for example, a radial packing ring. The shaft seal ring 178 seals the clearance gap between the opening 174 and the second shaft 106. Moreover, the plate 112 is provided with bores 180 that are arranged distributed around its circumference. In the embodiment shown, three bores 180 are provided. The bores 180 are used for the bolting of the plate 112 into threaded bores 182 provided correspondingly in the shaft end region 64. A sealing layer or a coating(not shown) may be provided for the sealing of the plate 112 with respect to the end face 11 that prevents an escape of lubricant between the plate 112 and end face 111.

The shaft end region 113 of the second shaft 106 is provided with connecting devices 190 that are configured in the form of a flange arrangement connected radially, as is shown in FIGS. 4 and . The connecting devices 190 include U-shaped projections 192 projecting axially from the shaft end region 113 of the second shaft 106 which are provided with two legs 194 extending transverse to the axis of rotation 90 on the end face of the shaft end region 113. A free space 196 is developed between the legs 194. Threaded bores 198 are provided on the end faces of the legs 194, where the end faces of the legs 194 extend at an angle to the floor of the free space 196 that is less than 90°. The end face of the shaft region 113 is provided with a threaded bore 200.

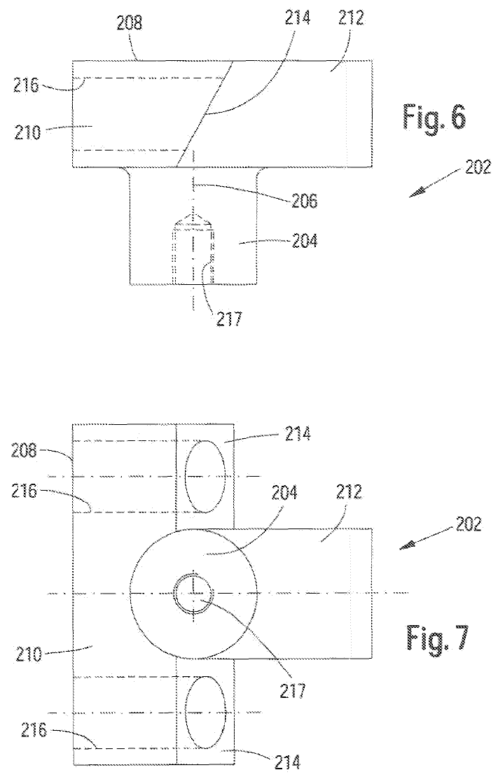

Moreover, the gearbox arrangement 10 is provided with a journal arrangement 202 that is connected with the shaft end region 113 of the second shaft 106. The journal arrangement 202 is shown in greater detail in FIGS. 6 and 7. The journal arrangement 202 is provided with a journal 204 with a journal axis 206 and connecting devices 208 in the form of a flange arrangement that provides a radial connection. The connecting devices 208 include a plate 210 on which a bridge 212 extended in the radial direction to the axis of the journal 2006. The plate 210 is located at a height that corresponds generally to the height of the U-shaped projection 192. The journal 204 extends axially to the journal axis 206 from the plate 210. The bridge 212 is configured in such a way that it is generally provided with the shape and the height of the free space 196. Connecting surfaces 214 are configured to the sides of the bridge 212, these connecting surfaces being slightly chamfered relative to the faces of the legs 194. The plate 210 is provided with bores 216 that conform in size and spacing to the threaded bores 198. Moreover, the journal 204 is provided with a threaded bore 217 arranged on its end face concentric to the journal axis 206.

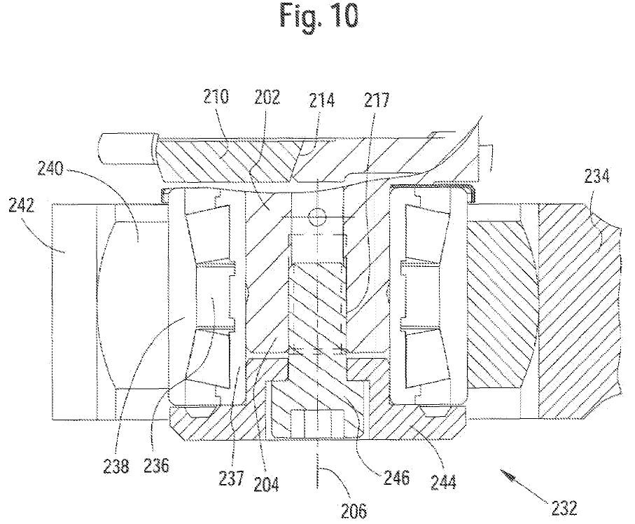

The journal arrangement 202 or the journal 204 is equipped with a bearing arrangement 232 (see FIG. 10), it is connected by means of connecting devices 234 for the operation of a cutter head (not shown). The bearing arrangement 232 includes a rolling contact bearing 236 with an inner race 237, and outer race 238 and a bushing 240 that is closed around its circumference, a bearing pan 242 closed around its circumference, where the bearing pan 242 establishes the connection with the connecting devices 234, an attachment plate 244 and an attaching screw 246. The rolling contact bearing 236 is configured as a roller bearing and engages the journal 204 with its inner race 237. The bushing 240 engages the outer race 238. The bushing 240 is supported in bearings in the bearing pan 242. The bushing 240 is provided with an outer surface that is configured spherically curved to the outside and arranged radially to the axis of rotation 206 of the journal 204. The bearing pan 242 is provided with an inner surface that is curved spherically inward congruent to the outer surface of the bushing 240 radially to the axis of rotation 206 of the journal 204. The bearing pan 242 is provided with recesses located radially opposite each other (not shown) that extend axially to the axis of the journal 206 along the inner surface of the bearing pan 242. Here the curvature of the spherical surfaces of the bushing 240 or the bearing pan 242 are provided with a radius of curvature that corresponds to the maximum outer radius of the bushing 240 or the maximum inner radius of the bearing pan 242. The recesses are used for the insertion of the bushing 240 into the bearing pan 242. The connecting device 234 is configured in the form of a guide rod that is rigidly connected to the bearing pan 242 or is configured as a one-piece component with the bearing pan 242. The connecting device 234 is connected by means of a connecting rod and screws to a cuter head mechanism (not shown).

The following will briefly go into the assembly as well as the relevant advantages of the gearbox arrangement 10.

Starting from the gearbox housing 16, this is equipped with the fre space 60 and provided with the second bearing 42 for the first shaft 20 as well as the first shaft seal ring 47. Following this, the first shaft is inserted into the first gearbox chamber region 22 through the first opening 30, the first bevel gear 80, preassembled with the second bearing 40 is guided over the shaft journal 78 over the second opening 32 of the second gearbox chamber region 24. The bevel gear 80 and the shaft step 76 are clamped axially by the shaft nut 94 and the shaft step 76 and the first shaft 20 is secured axially.

The second shaft 106 is preassembled with the first bearing 104 and the second bearing 110, where the second bearing 110 is secured axially by the snap ring 120 in the ring groove 118. The preassembled second shaft 106 is conducted into the cavity 88 of the first shaft 20 and immobilized axially by the plate 112 that was preassembled with the third shaft seal ring 178.

The third shaft 26 is preassembled to such a degree that the shaft journal 144 is equipped with the first bearing 49 and the second bevel gear 148 with the preassembled second bearing 50 is forced against the snap ring 140 fastened on the third shaft 26 in the ring groove 138. Immediately following, the preassembled third shaft 26 is conducted over the fourth opening 36 in the second gearbox chamber region 24 and the second bearing 50 is immobilized with the snap ring 54 in the ring groove 56. After installing the second shaft seal ring 57, the belt pulley 154 is conducted over the shaft end 132 and forced against the second bevel gear 148. The belt pulley 154 and the second bevel gear 148 are clamped against each other axially on the third shaft 26 by the shaft nut 134 and the snap ring 140

The connecting devices 190, 208 of the shaft end region 113 and the journal arrangement 202 are connected to each other by inserting the bridge 212 into the free space 196 and by bolting the plate 210 to the legs 194 over the bores 198 and 216. By connecting the connecting devices 190, 208 the journal 204 is immobilized eccentrically to the axis of rotation 90 of the second shaft 106.

The bearing arrangement 232 and the journal 202 are assembled by inserting the journal 202 into the inner race 237 of the rolling contact bearing 236. The bushing 240 is inserted transverse to the bearing pan 242 into the recesses, so that the radii of the bushing 240 and the bearing pan 242 extend perpendicularly to each other, (until the center of the bushing lies approximately at the level of the center of the bearing pan). By subsequently orienting the busing 240 toward the bearing pan 242, (so that the radii of the bushing 240 and the bearing pan 242 extend parallel to each other, then the bushing is brought into a position in which it is immobilized by the bearing pan 242 axially and radially to the axis of rotation of the journal 206. However, the busing 240 may be rotated about any desirable axis of rotation that extends through the center of the bearing pan, that is located perpendicular to the axis of rotation 206. Immediately following thereto the bushing 240 is slid over the outer race 238 and connected to the journal 204 along with the rolling contact bearing 236 together with the bushing 240 by means of the fastening disk 244 and the fastening screw 246. The spherical configuration of the bushing 240 or the bearing pan 242 permits an equalization movement of the connecting devices 234 or the connecting rod about an axis extending perpendicularly to the axis of rotation 206 of the journal 204. The closed configuration of the bushing 240 and the bearing pan 242 increase the stability and the resistance to wear of the bearing arrangement 232 and simplify the assembly, since conventional clamping arrangements for the bearing pan 242 can be omitted.

The gearbox arrangement 10 is driven by means of the belt pulley 154 on the third shaft 26. The first shaft 20 is driven about the axis of rotation 18 by means of the angle gearbox configured by the two bevel gears 80, 148. The rotational movement of the first shaft 20 brings about, on the one hand, a rotational movement of the second shaft 106 itself about the axis of rotation 90, since the second shaft 106 meshes with the cavity 60 over the gear tooth region 124 through the cavity opening 100. The journal 204 connected to the shaft end region 113 of the second shaft 106 by means of the connecting devices 19, 208, which is arranged eccentrically to the axis of rotation of the second shaft 106, thereby experiences an eccentric rotational movement about the axis of rotation 18 of the first shaft 20 that is superimposed by an eccentric rotational movement about the rotational axis 90 of the second shaft 106.

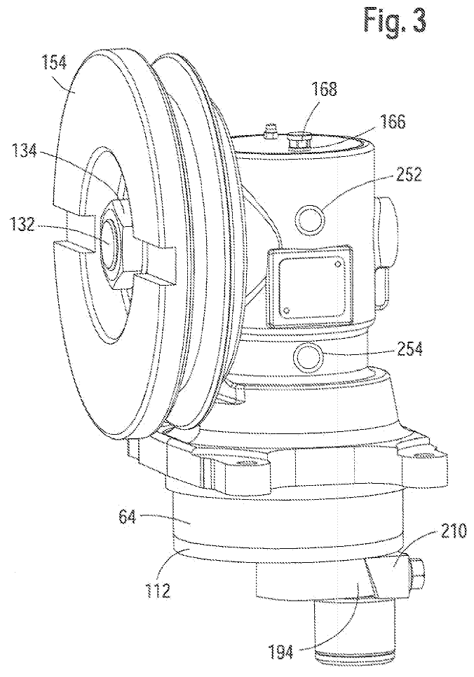

As shown in FIGS. 2 and 3, closure plugs 252, 254 are provided that are spaced at intervals along the axis of rotation 18, where an upper closure plug 252 is provided for the filling of the housing 16 with lubricant or gear oil, and a lower closure plug 254 is provided for draining the lubricant or gear oil. The closure plugs 252, 254 may be configured as screws that are screwed into the housing 16. The position of the upper closure plug 252 represents a maximum fill level for the lubricant or gear oil and is selected in such a way that the gearbox housing 16 can be filled with lubricant or gear oil so as to reach the region of the third shaft 26, on the other hand, the position of the lower closure plug 254 represents a minimum fill level for the lubricant or gear oil that is arranged in the common cylindrical transition region 28. The cross section passage area of the channel 156 is clearly reduced by the component 162 inserted into the gearbox chamber opening 158 or the bore 164 provided in the component 162. Since the cavity opening 160 is arranged eccentrically to the gearbox chamber opening 158 or to the axis of rotation 18, a suction develops when the first shaft 20 rotates which conveys the existing lubricant from the gearbox chamber opening 158 through the channel 156 to the cavity opening 160. The cross section passage area of the channel 156 reduced by the component 162 has the effect that a reduced amount of lubricant reaches the cavity 88. By having the bore 164 conform to the needs, the lubricating effect can be made to conform to the power requirements of the gearbox arrangement in a simple manner so that the lubricant conveyed through the channel corresponds to an optimum amount.

The ventilation arrangement 168 inserted into the housing cover 48 is used for the ventilation of the gearbox arrangement 10. In contrast to conventional arrangements, it has the advantage that the pipe section is configured very long in comparison to the diameter of the head 170. Thereby, the contamination of the filter element 172 can be slowed since, on the one hand, lubricant vapor ascending through the pipe can be deposited on the inside will of the pipe, one the other hand, foaming or splashing lubricant does not reach the filter so as directly to contaminate it.

All in all, the embodiments according to the invention of the gearbox arrangement permit the maintenance intervals to be lengthened, the temperature and pressure relationships in the gearbox housing 16 to be clearly improved and the cost of assembly to be significantly reduced.

Although the invention has been described on the basis of only one embodiment, anyone skilled in the art will perceive many varied alternative, modifications and variations, in the light of the foregoing description as well as the drawing, all of which fall under the present invention.

Having described the preferred embodiment, it will become apparent that various modifications can be made without departing from the scope of the invention as defined in the accompanying claims.

1. In a gearbox arrangement including a housing, a chamber enclosed by said housing, a first shaft supported in a first pair of bearings in the gearbox housing for rotation about a first axis of rotation, with one of said first pair of bearings being located in a first opening in the housing, a stepped cylindrical cavity provided in said first shaft in concentric relationship to a second axis of rotation disposed in parallel eccentric relationship to said first axis of rotation and with an end of said cavity defining an opening at one end of said first shaft, a second shaft being supported in a second pair of bearings provided in said cavity, with said second shaft being provided with at least one gear tooth area and being provided with an end region projecting axially from said cavity, and a third shaft supported in a third pair of bearings respectively provided in second and third openings in said gearbox housing, for rotation about a third axis of rotation which is angled relative to a plane lying on said first axis of rotation, the improvement comprising: said gearbox arrangement further including a plate fixed to said first shaft and being located for preventing axial movement of said second shaft; said plate containing a fourth opening in which is received said end region of said second shaft; and a plurality of sealing devices being provided for respectively sealing said first, second and third openings in said housing and said fourth opening in said plate in such a way that an escape of lubricant from said gearbox housing between the gearbox housing and the first and third shafts, and between the plate and second shaft is prevented.

2. The gearbox arrangement, as defined in claim 1 wherein said one end of said first shaft defines a flat end face extending perpendicular to said first axis of rotation; and said plate being fastened flat against said flat end face.

3. The gearbox arrangement, as defined in claim 1, wherein said housing is provided with at least one closure plug arranged along said first axis of rotation.

4. The gearbox arrangement, as defined in claim 1, wherein said plurality of sealing devices are configured as shaft sealing rings.

5. The gearbox arrangement, as defined in claim 1, wherein said second shaft includes a bearing region supported in one of said third pair of bearings located in said cavity in the vicinity of said opening of said cavity; and said plate engaging and immobilizing said one of said third pair of bearings from moving axially from said cavity.

6. The gearbox arrangement, as defined in claim 1, wherein said second shaft is configured as a one-piece component including a plurality of individual axially extending regions including said end region, with outside diameters of all of said individual regions, excluding said end region, being no longer than an outside diameter of said end region.

7. The gearbox arrangement, as defined in claim 1, and further including an internal gear fixed to said housing and being meshed with said gear tooth area of said second shaft.

8. The gearbox arrangement, as defined in claim 1, wherein one of said third pair of bearings is a needle bearing.

9. The gearbox arrangement, as defined in claim 1, wherein another of said third pair of bearings is immobilized axially in the direction to the outside of the gearbox housing by a snap ring contained in a ring groove provided in said housing.

10. The gearbox arrangement, as defined in claim 9, and further including a first angle gear located on said third shaft and having a bearing area engaged by said another of said third pair of bearings; and a snap ring being provided in a snap ring groove in said third shaft for preventing axial movement of said first angle gear further into said gearbox chamber.

11. The gearbox arrangement, as defined in claim 10, and further including a second angle gear fastened to said first shaft and meshed with said first angle gear; and another of said second pair of bearings being received on a bearing area of said second angle gear so as to constrain said second angle gear and said first shaft in a radial direction relative to said first axis of rotation.

12. The gearbox arrangement, as defined in claim 1, wherein said gearbox housing is provided with a further opening; a cover being coupled to said housing in sealing relationship to said further opening; and a ventilating arrangement being provided in said covering for connecting an interior of said chamber with surroundings outside said housing.

13. The gearbox arrangement, as defined in claim 1, and further including a journal mounted to said shaft end region of said second shaft and having a journal axis extending eccentric to said axis of rotation of said second shaft.

14. The gearbox arrangement, as defined in claim 13, wherein said journal includes a rolling contact bearing.

15. The gearbox arrangement, as defined in claim 14, wherein said rolling contact bearing is enclosed by a bushing having an outer surface which is bowed spherically; and a bearing pan being provided with an inner surface that is congruent to, and engages said outer surface of said bushing.

16. The gearbox arrangement, as defined in claim 15, wherein said bushing and said bearing pan define a closed circumference, with said bearing pan being equipped with recesses located radially opposite each other and extending axially along an inner surface of said bearing pan for permitting said bushing to be inserted into said recesses.

17. The gearbox arrangement, as defined in claim 15, and further including a connecting device, which is adapted for connection to a cutter head, being coupled to said bearing pan.
